(19) United States
(12) Patent Application Publication
(10) Pub. No.: US 2025/0373063 A1
(43) Pub. Date: Dec. 4, 2025

(54) SYSTEMS AND METHODS FOR MANAGING BATTERY IN LOW-TEMPERATURE ENVIRONMENTS

(71) Applicant: Dell Products L.P., Round Rock, TX (US)

(72) Inventors: Jui Chin FANG, Taipei City (TW); Adolfo S. MONTERO, Pflugerville, TX (US)

(73) Assignee: Dell Products L.P., Round Rock, TX (US)

(21) Appl. No.: 18/732,717

(22) Filed: Jun. 4, 2024

(51) Int. Cl. H02J 7/00

(52) U.S. Cl. CPC H02J 7/007194; H02J 7/0047; H02J 7/007182

(57) ABSTRACT

An information handling system may include a battery configured to power components of the information handling system, a temperature sensor, and a management controller communicatively coupled to the battery and configured to obtain a temperature associated with the battery and based on the temperature, cause the information handling system to operate in one of a plurality of operating modes. The plurality of operating modes may include at least: a powered down mode when the temperature is below a first threshold in which the information handling system is powered down; an early sign of life mode when the temperature is above the first threshold and below a second threshold in which a discharge rate of the battery is limited to a maximum discharge rate; and a normal mode when the temperature is above the second threshold in which the discharge rate of the battery is independent of the temperature.

### TECHNICAL FIELD

The present disclosure relates in general to information handling systems, and more specifically to systems and methods for managing a battery of an information handling system in low-temperature environments.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many modern information handling systems utilize one or more rechargeable batteries for powering electrical and electronic components of the information handling system. Such batteries may be used when an external power supply is not available to the information handling system, whether such external power supply is unavailable due to a power grid failure or because a user decouples the information handling system from the external power supply for mobile usage of the information handling system.

A common type of battery used in information handling systems is a lithium-ion battery. One disadvantage of lithium-ion batteries is that the chemical characteristics of a battery cell (including its internal impedance and electrical current generating capability) may be strongly impacted when operating below 0° C. Accordingly, some information handling systems may be configured to operate at above a certain threshold temperature, in order to prevent damage to the battery and/or an undesirable user experience should the information handling system shut down in order to protect the battery from damage. However, use of a single threshold temperature in order to enter “normal operation” of the information handling system may not be sufficient, as the battery chemistry's temperature response may be transient and battery impedance may remain high for a period of time after a rise in temperature. Accordingly, if there is an attempt to discharge the battery at a normal C-rate (i.e., a measure of the rate at which a battery is discharged relative to its maximum capacity), the larger battery impedance may cause a large voltage drop under load, which may in turn cause the information handling system to unexpectedly shut down, leading to negative user experience.

### SUMMARY

In accordance with the teachings of the present disclosure, the disadvantages and problems associated with battery chemistry characteristics at low temperatures may be reduced or eliminated.

In accordance with embodiments of the present disclosure, an information handling system may include a battery configured to power components of the information handling system, a temperature sensor, and a management controller communicatively coupled to the battery and configured to obtain a temperature associated with the battery and based on the temperature, cause the information handling system to operate in one of a plurality of operating modes. The plurality of operating modes May include at least: a powered down mode when the temperature is below a first threshold in which the information handling system is powered down; an early sign of life mode when the temperature is above the first threshold and below a second threshold in which a discharge rate of the battery is limited to a maximum discharge rate; and a normal mode when the temperature is above the second threshold in which the discharge rate of the battery is independent of the temperature.

In accordance with these and other embodiments of the present disclosure, a method a method may include obtaining a temperature associated with a battery and based on the temperature, causing an information handling system having components powered by the battery to operate in one of a plurality of operating modes. The plurality of operating modes may include at least: a powered down mode when the 30 temperature is below a first threshold in which the information handling system is powered down; an early sign of life mode when the temperature is above the first threshold and below a second threshold in which a discharge rate of the battery is limited to a maximum discharge rate; and a normal mode when the temperature is above the second threshold in which the discharge rate of the battery is independent of the temperature.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to obtain a temperature associated with a battery and based on the temperature, cause an information handling system having components powered by the battery to operate in one of a plurality of operating modes, The plurality of operating modes may include at least: a powered down mode when the temperature is below a first threshold in which the information handling system is powered down; an early sign of life mode when the temperature is above the first threshold and below a second threshold in which a discharge rate of the battery is limited to a maximum discharge rate; and a normal mode when the temperature is above the second threshold in which the discharge rate of the battery is independent of the temperature.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawing, in which like reference numbers indicate like features, and wherein:

FIG. 1 illustrates a block diagram of an example information handling system, in accordance with certain embodiments of the present disclosure; and

FIG. 2 illustrates a flow chart of an example method for managing a battery in low-temperature conditions, in accordance with embodiments of the present disclosure.

### DETAILED DESCRIPTION

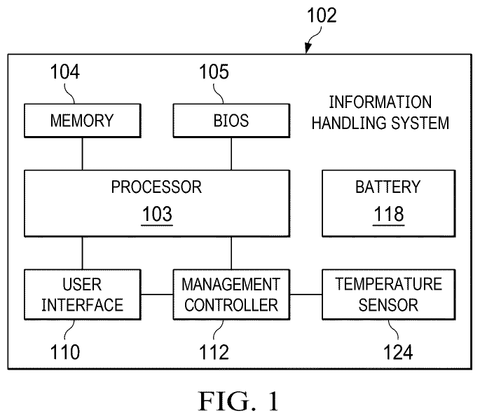

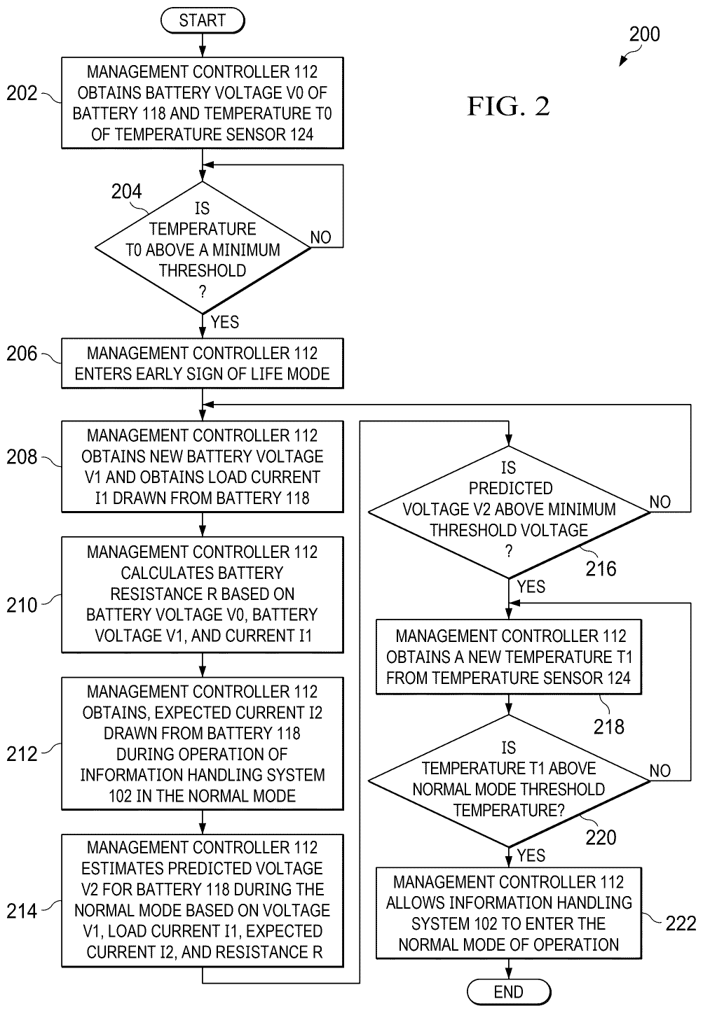

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSes), buses, memories, I/O devices and/or interfaces, storage resources, network interfaces, motherboards, and/or any other components and/or elements of an information handling system.

FIG. 1 illustrates a block diagram of an example information handling system 102, in accordance with certain embodiments of the present disclosure. In some embodiments, information handling system 102 may be a server. In other embodiments, information handling system 102 may be a personal computer (e.g., a desktop computer or a portable computer). In yet other embodiments, information handling system 102 may be a mobile device (e.g., a handheld gaming device, a smartphone, a tablet, etc.). As depicted in FIG. 1, information handling system 102 may include a processor 103, a memory 104 communicatively coupled to processor 103, a basic input/output system (BIOS) 105 communicatively coupled to processor 103, a management controller 112 communicatively coupled to processor 103, a user interface 110 communicatively coupled to processor 103 and management controller 112, a battery 118 electrically coupled to selected components of information handling system 102, and temperature sensor 124 communicatively coupled to management controller 112.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 105, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, BIOS code may be configured to set components of information handling system 102 into a known state, so that one or more applications (e.g., an operating system or other application programs) stored on compatible media (e.g., memory 104) may be executed by processor 103 and given control of information handling system 102.

User interface 110 may comprise any instrumentality or aggregation of instrumentalities by which a user may interact with information handling system 102. For example, user interface 110 may permit a user to input data and/or instructions into information handling system 102 (e.g., via a keyboard, pointing device, push button, and/or other suitable component), and/or otherwise manipulate information handling system 102 and its associated components. User interface 110 may also permit information handling system 102 to communicate data to a user, e.g., by way of a display device or visual indicators such as light-emitting diodes.

Management controller 112 may be configured to provide out-of-band management facilities for management of information handling system 102. Such management may be made by management controller 112 even if information handling system 102 is powered off or powered to a standby state. Management controller 112 may include a processor, memory, and an out-of-band d network interface separate from and physically isolated from an in-band network interface. In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC). In other embodiments, management controller 112 may comprise a battery management unit of battery 118.

In accordance with embodiments of the present disclosure, management controller 112 may, among other functions, perform battery management of battery 118 in low-temperature conditions, as described in greater detail below.

Battery 118 may comprise a power source having one or more electrochemical cells with external connections for powering one or more electrical devices of information handling system 102, including processor 103, memory 104, BIOS 105, and management controller 112. In particular, battery 118 may store chemical energy which may be converted to electrical energy to power one or more electrical devices. In some embodiments, battery 118 may comprise a rechargeable battery, for which electrical energy delivered to battery 118 may be converted to chemical energy, for storage and later conversion into electrical energy. In some embodiments, battery 118 may comprise a lithium-ion battery.

Temperature sensor 124 may comprise any system, device, or apparatus (e.g., a thermometer, thermistor, etc.) configured to communicate a signal to management controller 112 indicative of a temperature within information handling system 102, in particular a temperature of or proximate to battery 118.

In addition to processor 103, memory 104, BIOS 105, user interface 110, management controller 112, battery 118, and temperature sensor 124, information handling system 102 may include one or more other information handling resources.

In operation, management controller 112 may manage battery 118 in low-temperature conditions by separating operating parameters into various temperature operating regions. For example, the table below illustrates an example low-temperature battery management algorithm for a first type of battery 118 (e.g., a factory-replaceable unit).

| Temperature | Minimum | System | |
|---|---|---|---|
| Range | SOC | Power Limit | Actions |
| <−29° C. | N/A | N/A | Disable system operation; |
| | | | power on to S5 to determine |
| | | | temperature; display |
| | | | warning to user interface |
| −29° C. | 90% | 16.2 W | Operate in Early Sign of |
| to −27° C. | | | Life Mode; limit discharge |
| | | | rate to 0.4 C; display |
| | | | warning to user interface |
| −26° C. | 90% | 48.7 W | Limit discharge rate to 1.2 C |
| to −6° C. | | | |

| | |
|---|---|
| >−6° C. | Normal Operation |

As another example, the table below illustrates an example low-temperature battery management algorithm for a second type of battery 118 (e.g., a customer-replaceable unit).

| Temperature | Minimum | System | |
|---|---|---|---|
| Range | SOC | Power Limit | Actions |
| <−29° C. | N/A | N/A | Disable system operation; |
| | | | power on to S5 to determine |
| | | | temperature; display |
| | | | warning to user interface |
| −29° C. | 90% | 12.2 W | Operate in Early Sign of |
| to −16° C. | | | Life Mode; limit discharge |
| | | | rate to 0.4 C; display |
| | | | warning to user interface |
| −15° C. | 90% | 24.3 W | Limit discharge rate to 1.2 C |
| to −6° C. | | | |

| | |
|---|---|
| >−6° C. | Normal Operation |

As seen in the tables above, management controller 112 may execute a low-temperature battery management algorithm defined by a plurality of temperature ranges for battery 118 (as sensed by temperature sensor 124) and for each range, an associated operational state. For example, for temperatures in a first range (e.g., <29° C.), management controller 112 may cause information handling system 102 to be powered off, and power on only to a standby power mode (e.g., S5) in order to monitor temperature. In such range, management controller 112 may also cause a warning to be displayed (e.g., via light-emitting diodes) to user interface 110 indicating that system operation is disabled due to low temperature.

As another example, for temperatures in a second range (e.g., −29° C. to −27° C. for factory-replaceable battery units and −29° C. to −16° C. for customer-replaceable battery units) management controller 112 may allow information handling system 102 to enter a restricted early sign of life mode, limiting discharge of battery 118 to a particular C-rate (e.g., 0.6 C for factory-replaceable battery units and 0.4 C for customer-replaceable battery units). As is known in the art, a C-rate for a battery is its rate of hourly discharge relative to its charge capacity. Thus, a C-rate of 1.00 is one in which a battery would fully discharge in one hour, a C-rate of 2.0 C is one in which a battery would fully discharge in 30 minutes, and a C-rate of 0.5 C is one in which a battery would fully discharge in two hours. In some embodiments, management controller 112 may condition operation in the early sign of life mode on battery 118 having a minimum state of charge (e.g., 90%). In these and other embodiments, management controller 112 may also limit power consumption of information handling system 102 in the restricted early sign of life mode by limiting the C-rate. Such C-rate may be based on expected operational characteristics of the battery associated with the physics and chemistry of battery 118 in such temperature ranges. A restricted early sign of life mode may be one in which a host system of information handling system 102 remains inactive, but other components (e.g., out-of-band components) may be powered on.

As a further example, for temperatures in a third range (e.g., −26° C. to −6° C. for factory-replaceable battery units and −15° C. to −6° C. for customer-replaceable battery units) management controller 112 may allow information handling system 102 to enter a lesser-restricted early sign of life mode, limiting discharge of battery 118 to a particular C-rate (e.g., 1.2 C). In some embodiments, management controller 112 may condition operation in the restricted mode on battery 118 having a minimum state of charge (e.g., 90%). In these and other embodiments, management controller 112 may also limit power consumption of information handling system 102 in the lesser-restricted early sign of life mode by limiting the C-rate. Such C-rate may be based on expected operational characteristics of the battery associated with the physics and chemistry of battery 118 in such temperature ranges. A lesser-restricted early sign of life mode may be one in which a host system of information handling system 102 is allowed to boot, but other components (e.g., out-of-band components) may be powered on, subject to the power restrictions imposed by management controller 112.

Further, while in either the restricted early sign of life mode or the lesser-restricted early sign of life mode, management controller 112 may estimate a predicted voltage of the battery during the early sign of life mode based on an estimated resistance of the battery and an expected current drawn from the battery during the early sign of life mode. Further, management controller 112 may also compare the predicted voltage to a threshold voltage and further limit the discharge rate of the battery during an early sign of life mode if the predicted voltage is below the threshold voltage.

As an additional example, for temperatures in a fourth range (e.g., −5° C. and above) management controller 112 may allow information handling system 102 to operate without any low-temperature power restrictions, and to allow power to be drained from battery 118 in DC mode in accordance with a power table for information handling system 102.

Further, management controller 112 may be configured to predict a voltage of battery 118 during boots of information handling system 102 in low-temperature environments by tracking the dynamic battery impedance as well as the maximum allowed discharge rate currents within the different temperature ranges. As part of this voltage prediction, management controller 112 may also ensure that a minimum threshold voltage will be maintained in the normal mode of operation to prevent an undervoltage scenario from occurring during the normal operation which may lead to powering down of information handling system 102 or its components. Accordingly, management controller 112 may condition entry into the normal mode of operation not only based on temperature, but also condition entry into the normal mode of operation based on the voltage prediction satisfying minimum voltage requirements. An example of this prediction capability is set forth below in reference to method 200 of FIG. 2.

FIG. 2 illustrates a flow chart of an example method 200 for managing a battery in low-temperature conditions, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, management controller 112 may obtain battery voltage V0 of battery 118 and a temperature TO of temperature sensor 124. At step 204, management controller 112 may determine if temperature TO is above a minimum threshold (e.g., −29° C.). If above the minimum threshold, method 200 may proceed to step 206. Otherwise, method 200 may return to step 202.

At step 206, management controller 112 may enter an early sign of life mode (e.g., restricted or less-restricted early sign of life mode, based on temperature). At step 208, management controller 112 may obtain a new battery voltage V1 and obtain a load current I1 drawn from battery 118. At step 210, management controller 112 may calculate battery resistance R based on battery voltage V0, battery voltage V1, and current I1 (e.g., R=(V0−V1)/I1).

At step 212, management controller 112 may obtain, from a power table of information handling system 102, the expected current I2 drawn from battery 118 during operation of information handling system 102 in the normal mode. At step 214, management controller 112 may estimate a predicted voltage V2 for battery 118 during the normal mode based on voltage V1, load current I1, expected current I2, and resistance R (e.g., V2=V1−[R(I2−I1)].

At step 216, management controller 112 may compare predicted voltage V2 to a minimum threshold voltage for battery 118. If predicted voltage V2 exceeds the minimum threshold voltage, method 200 may proceed to step 218. Otherwise, method 200 nay proceed again to step 208.

At step 218, management controller 112 may obtain a new temperature T1 from temperature sensor 124. At step 220, management controller 112 may compare temperature T1 to a normal mode threshold temperature. If temperature T1 is above the normal mode threshold temperature, method 200 may proceed to step 222. Otherwise, method 200 may proceed again to step 218.

At step 222, management controller 112 may allow information handling system 102 to enter the normal mode of operation. After completion of step 222, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using information handling system 102 and/or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. An information handling system comprising:
a battery configured to power components of the information handling system;
a temperature sensor; and
a management controller communicatively coupled to the battery and configured to:
obtain a temperature associated with the battery; and
based on the temperature, cause the information handling system to operate in one of a plurality of operating modes, the plurality of operating modes comprising at least:
a powered down mode when the temperature is below a first threshold in which the information handling system is powered down;
an early sign of life mode when the temperature is above the first threshold and below a second threshold in which a discharge rate of the battery is limited to a maximum discharge rate; and
a normal mode when the temperature is above the second threshold in which the discharge rate of the battery is independent of the temperature.

2. The information handling system of claim 1, the plurality of operating modes further comprising at least a second early sign of life mode, wherein:
the early sign of life mode occurs when the temperature is above the first threshold and below a third threshold and the discharge rate of the battery is limited to a first maximum discharge rate, wherein the first maximum discharge rate is related to operational characteristics of the battery associated with physics and chemistry of the battery in a temperature range of the early sign of life mode; and
the second early sign of life mode occurs when the temperature is above the third threshold and below the second threshold and the discharge rate of the battery is limited to a second maximum discharge rate greater than the first maximum discharge rate, wherein the second maximum discharge rate is related to operational characteristics of the battery associated with physics and chemistry of the battery in a temperature range of the second early sign of life mode.

3. The information handling system of claim 1, wherein an early sign of life subsystem of the management controller is configured to communicate an alert to a user of an operating mode of the information handling system.

4. The information handling system of claim 1, the management controller further configured to, while in the early sign of life mode, estimate a predicted voltage of the battery during the normal mode based on an estimated resistance of the battery and an expected current drawn from the battery during the normal mode.

5. The information handling system of claim 4, the management controller further configured to:
compare the predicted voltage to a threshold voltage; and
permit the information handling system to operate in the normal mode if the temperature is above the second threshold and the predicted voltage is above the threshold voltage.

6. The information handling system of claim 5, wherein the threshold voltage is a minimum voltage for operation of the battery in order to prevent an undervoltage scenario from occurring during the normal mode leading to powering down of the information handling system or its components.

7. The information handling system of claim 1, the management controller further configured to, while in the early sign of life mode:
estimate a predicted voltage of the battery during the early sign of life mode based on an estimated resistance of the battery and an expected current drawn from the battery during the early sign of life mode;
compare the predicted voltage to a threshold voltage; and
further limit the discharge rate of the battery if the predicted voltage is below the threshold voltage.

8. A method comprising:
obtaining a temperature associated with a battery; and
based on the temperature, causing an information handling system having components powered by the battery to operate in one of a plurality of operating modes, the plurality of operating modes comprising at least:
a powered down mode when the temperature is below a first threshold in which the information handling system is powered down;
an early sign of life mode when the temperature is above the first threshold and below a second threshold in which a discharge rate of the battery is limited to a maximum discharge rate; and
a normal mode when the temperature is above the second threshold in which the discharge rate of the battery is independent of the temperature.

9. The method of claim 8, the plurality of operating modes further comprising at least a second early sign of life mode, wherein:
the early sign of life mode occurs when the temperature is above the first threshold and below a third threshold and the discharge rate of the battery is limited to a first maximum discharge rate, wherein the first maximum discharge rate is related to operational characteristics of the battery associated with physics and chemistry of the battery in a temperature range of the early sign of life mode; and
the second early sign of life mode occurs when the temperature is above the third threshold and below the second threshold and the discharge rate of the battery is limited to a second maximum discharge rate greater than the first maximum discharge rate, wherein the second maximum discharge rate is related to operational characteristics of the battery associated with physics and chemistry of the battery in a temperature range of the second early sign of life mode.

10. The method of claim 8, further comprising communicating an alert to a user of an operating mode of the information handling system by an early sign of life subsystem of a management controller of the information handling system.

11. The method of claim 8, further comprising, while in the early sign of life mode, estimating a predicted voltage of the battery during the normal mode based on an estimated resistance of the battery and an expected current drawn from the battery during the normal mode.

12. The method of claim 11, further comprising:
comparing the predicted voltage to a threshold voltage; and
permitting the information handling system to operate in the normal mode if the temperature is above the second threshold and the predicted voltage is above the threshold voltage.

13. The method of claim 12, wherein the threshold voltage is a minimum voltage for operation of the battery in order to prevent an undervoltage scenario from occurring during the normal mode leading to powering down of the information handling system or its components.

14. The method of claim 8, further comprising, while in the early sign of life mode:
estimating a predicted voltage of the battery during the early sign of life mode based on an estimated resistance of the battery and an expected current drawn from the battery during the early sign of life mode;
comparing the predicted voltage to a threshold voltage; and
further limiting the discharge rate of the battery if the predicted voltage is below the threshold voltage.

15. An article of manufacture comprising:
a non-transitory computer-readable medium; and
computer-executable instructions carried on the computer-readable medium, the instructions readable by a processor, the instructions, when read and executed, for causing the processor to:
obtain a temperature associated with a battery; and
based on the temperature, cause an information handling system having components powered by the battery to operate in one of a plurality of operating modes, the plurality of operating modes comprising at least:
a powered down mode when the temperature is below a first threshold in which the information handling system is powered down;
an early sign of life mode when the temperature is above the first threshold and below a second threshold in which a discharge rate of the battery is limited to a maximum discharge rate; and
a normal mode when the temperature is above the second threshold in which the discharge rate of the battery is independent of the temperature.

16. The article of claim 15, the plurality of operating modes further comprising at least a second early sign of life mode, wherein:
the early sign of life mode occurs when the temperature is above the first threshold and below a third threshold and the discharge rate of the battery is limited to a first maximum discharge rate, wherein the first maximum discharge rate is related to operational characteristics of the battery associated with physics and chemistry of the battery in a temperature range of the early sign of life mode; and
the second early sign of life mode occurs when the temperature is above the third threshold and below the second threshold and the discharge rate of the battery is limited to a second maximum discharge rate greater than the first maximum discharge rate, wherein the second maximum discharge rate is related to operational characteristics of the battery associated with physics and chemistry of the battery in a temperature range of the second early sign of life mode.

17. The article of claim 15, the instructions for further causing the processor to communicate an alert to a user of an operating mode of the information handling system by an early sign of life subsystem of a management controller of the information handling system.

18. The article of claim 15, the instructions for further causing the processor to, while in the early sign of life mode, estimate a predicted voltage of the battery during the normal mode based on an estimated resistance of the battery and an expected current drawn from the battery during the normal mode.

19. The article of claim 18, the instructions for further causing the processor to:
compare the predicted voltage to a threshold voltage; and
permit the information handling system to operate in the normal mode if the temperature is above the second threshold and the predicted voltage is above the threshold voltage.

20. The article of claim 19, wherein the threshold voltage is a minimum voltage for operation of the battery in order to prevent an undervoltage scenario from occurring during the normal mode leading to powering down of the information handling system or its components.

21. The article of claim 15, the instructions for further causing the processor to, while in the early sign of life mode:
estimate a predicted voltage of the battery during the early sign of life mode based on an estimated resistance of the battery and an expected current drawn from the battery during the early sign of life mode;
compare the predicted voltage to a threshold voltage; and
further limit the discharge rate of the battery if the predicted voltage is below the threshold voltage.
